(19) United States
(12) Patent Application Publication
(10) Pub. No.: US 2011/0001851 A1
(43) Pub. Date: Jan. 6, 2011

(54) IMAGE PROCESSING APPARATUS AND IMAGE INPUT APPARATUS

(76) Inventor: Kenji Nakamura, Osaka (JP)

Correspondence Address: MCDERMOTT WILL & EMERY LLP, 600 13TH STREET, NW, WASHINGTON, DC, 20005-3096, US

(21) Appl. No.: 12/865,999

(22) PCT Filed: Oct. 7, 2009
(86) PCT No.: PCT/JP2009/005221

§ 371 Date: Aug. 3, 2010

(30) Foreign Application Priority Data
Dec. 19, 2008 (JP) 2008-323924

(51) Int. Cl. H04N 5/217

(52) U.S. Cl. 348/241; 348/E05.078

(57) ABSTRACT

Provided are a first communication circuit for communicating with an AFE, an image noise detecting circuit for detecting whether or not an image noise is superposed on a digital image signal, and a communication control circuit for outputting a communication forbidding signal when the image noise detecting circuit detects that the image noise is superposed on the digital image signal. The first communication circuit arrests the communication when the communication forbidding signal is detected.

### FIELD OF THE INVENTION

The present invention relates to an image processing apparatus mounted in an equipment expected to be used near a source of emission of a high voltage and high frequency signal, and a technology which effectively avoids any adverse impacts from an image noise resulting from the high voltage and high frequency signal. The present invention more particularly relates to an image processing apparatus and an image input apparatus mounted in an endoscope with an electric scalpel which generates a high voltage and high frequency signal, and a built-in camera of a mobile telephone susceptible to electric waves for communication.

### BACKGROUND OF THE INVENTION

The document of Japanese Patent Application No. 2008-323924 filed on Dec. 19, 2008 in whole, including its specification, drawings, and Scope of Claims is hereby incorporated by reference in the specification of the present application.

The application of a digital camera module is now expanding as its imaging unit is reducing its dimensions, for example, to monitoring and medical field. The digital camera module is an apparatus including an imaging device, an analogue front end (hereinafter, simply called AFE) which converts an analog image signal obtained by the imaging device into a digital image signal, and a digital signal processor (hereinafter, simply called DSP) which image-processes the digital image signal. As digital cameras are equipped with a larger number of pixels and functions in recent years, control signals (control signals for controlling, for example, exposure time and frame rate) are communicated between the AFE and the DSP at an increasingly higher speed within the digital camera module, and a communication speed between the digital camera module and other devices mounted therewith is also increasing.

In cameras for medical use (endoscope), an electric scalpel driven by a high voltage at a high frequency is provided near a camera module to be inserted in a body. A high voltage and high frequency signal created by the electric scalpel in action often triggers communication errors between the DSP and AFE, between the DSP and imaging device, and between the DSP and a processor. The processor described in this specification functions as a controller in charge of controlling loaded devices (for example, camera for medial use).

In the built-in camera of the mobile telephone, a high frequency electric wave generated by the mobile telephone often similarly causes communication errors within the camera module and also between the camera module and a main unit of the mobile telephone.

FIG. 7 is a block diagram illustrating a structure of a conventional endoscope with an electric scalpel (for example, see the Patent Document 1). The endoscope with an electric scalpel has an imaging unit 10 to be inserted in a body equipped with an imaging device 11, an operation unit 20 which accepts a doctor's manipulation when he inserts the imaging unit 10 in a body or uses a processor, a processor 30 which is a principal unit of the endoscopic camera system which controls an overall operation of the endoscope, and an electric scalpel drive unit 40. An imaging signal obtained by the imaging device 11 is transmitted to the AFE 22 through an insertion cable 12 to be digitalized therein. The digital image signal thus obtained is image-processed by the DSP 23 and then transmitted to the processor 30 through an extension cable 31. The DSP 23 controls its own operation depending on control signals acquired by communicating with the processor 30 or the operation unit 20 (control signals for controlling, for example, exposure time and frame rate), and transmits the control signals to the AFE 22 or the imaging device 11 by communicating with these devices to constantly keep an optimal control of the endoscope.

When the electric scalpel drive unit 40 starts its action to incise an affected area of the body using a high voltage and high frequency signal generated by an electric scalpel 42, an image noise resulting from the high voltage and high frequency signal is possibly generated and mingled with the AFE-DSP, DSP-imaging device, or DSP-processor communication. In the case where the image noise is thus mingled with the communication, it may result in failure or error to control the camera module, and the worst scenario is cessation of the image signal during a surgical operation (generally called black out).

There is no synchronization between the operation of the endoscope unit (including the imaging unit 10, operation unit 20 and processor 30) and the operation of the electrical scalpel driving unit 40. Therefore, the endoscope unit is unable to detect the operation status of the electric scalpel 42. In the case where the image noise resulting from the high frequency signal transmitting through an electric scalpel cable 41 is superposed on a communication signal between the module devices, the AFE 22 and the imaging unit 11 undergo malfunctioning or completely stop their operations. As a result, an image output can be no longer obtained from the endoscope.

To avoid the inconvenience, an electric scalpel operation detecting circuit 80 is conventionally provided in the operation unit 20. The electric scalpel operation detecting circuit 80 directly monitors electric signal circuits near the DSP 23 (for example, communication circuit) to determine whether the electric scalpel 42 is currently in action or at halt based on counted pulse signals mingled with the electric signals. When it is determined that the electric scalpel 42 is currently operating, the electric scalpel operation detecting circuit 80 stops the communication of the digital camera module.

### PRIOR ART DOCUMENT

### Patent Document

Patent Document 1: Unexamined Japanese Patent Applications Laid-Open No. 57-110230

### SUMMARY OF THE INVENTION

### Problem to be Solved by the Invention

The conventional technology disclosed in the Patent Document 1 is technically characterized in that the communication of the camera module is discontinued when the electric scalpel operation detecting circuit 80 detects that the electric scalpel 42 is currently operating. However, it is not always affected by the operation of the electric scalpel 42 to obtain the image output from the camera module. In view of the fact, the conventional technology overly controls the communication of the camera module because the communication is disrupted anyway regardless of whether or not it negatively impacts the image acquirement. Another disadvantage is an increase of the operation unit 20 in size because of the electric scalpel operation detecting circuit 80 additionally provided therein.

The present invention was carried out to solve the problems described so far, and a main object thereof is to accomplish an optimal control to the utmost extent.

### Means for Solving the Problems

An image processing apparatus according to the present invention comprises:

an AFE for generating a digital image signal from an image signal; and

a DSP for image-processing the digital image signal, wherein

the DSP includes:

a first communication circuit for communicating with the AFE;

an image noise detecting circuit for detecting whether or not an image noise is superposed on the digital image signal; and

a communication control circuit for outputting a communication forbidding signal when the image noise detecting circuit detects that the image noise is superposed on the digital image signal, and

the first communication circuit arrests the communication when the communication forbidding signal is detected.

According to the present invention, the communication control circuit outputs the communication forbidding signal to be detected by the first communication circuit as far as the image noise detecting circuit detects the image noise. The technical requirement according to the present invention wherein the communication control circuit outputs the communication forbidding signal based on the detected image noise is totally different in effect to a structure where the operation of an electric scalpel is interpreted as substantially equaling the occurrence of an image noise, and whether or not the electric scalpel is currently operating is determined by detecting a high frequency signal which drives the electric scalpel to arrest the communication with the AFE upon detecting the operation of the electric scalpel.

A problem caused by driving the electric scalpel is the disturbance of an image caused by the image noise mingled with the image signal. Though empirically known that it generates the image noise to drive the electric scalpel, the image noise is not always generated every time when the electric scalpel is driven. The image noise does not occur at all in some cases during the action of the electric scalpel. The conventional technology is technically disadvantageous in that the communication is often overly disrupted based on the recognition that the action of the electric scalpel immediately results in the image noise. Thus, the conventional technology halts the communication more often than necessary.

On the contrary, the present invention enables a control operation to a just right extent by stopping the communication as far as the image noise is detected, thus avoiding any excess control. This technical requirement allows the use of the electrical scalpel unless the image noise is generated. To put it differently, the communication remains continued in the case where the high frequency signal is generated but its frequency is not as high as adversely impacts the image signal, and an optimal control is feasible to the utmost extent. When the image noise is generated, the communication is halted to reliably control the AFE.

According to a preferred mode of the present invention, the DSP further includes a second communication circuit for communicating with a processor which controls the DSP, wherein the second communication circuit arrests the communication when the communication forbidding signal is detected.

According to the structure, the AFE can be more reliably controlled.

The communication control circuit preferably outputs the communication forbidding signal to the processor using the second communication circuit. Thus configured, the second communication circuit can notify the processor of the occurrence of the image noise resulting from the high frequency signal generated by the drive of the electric scalpel before arresting the communication.

According to another preferred mode of the present invention, the image noise detecting circuit presets one or a plurality of pixels to be marked and a peripheral pixel around the pixel to be marked in the digital image signal, and determines that the image noise is superposed on the pixel to be marked when a differential between a pixel value of the pixel to be marked and a pixel value of the peripheral pixel is at least a differential threshold value previously set.

According to the another preferred mode, the image noise detecting circuit preferably presets a plurality of the peripheral pixels for the one pixel to be marked, and uses an average pixel value of the plurality of the peripheral pixels as a pixel value of the peripheral pixels.

The image noise detecting circuit further preferably includes:

a peripheral pixel averaging circuit for calculating the average pixel value of the peripheral pixels; and

a differential circuit for calculating a differential between the pixel value of the pixel to be marked and the average pixel value, wherein

the image noise detecting circuit determines that the image noise is superposed on the pixel to be marked when the differential between the pixel value of the pixel to be marked and the average pixel value is at least the differential threshold value.

Thus configured, the image noise caused by the high frequency signal generated when the electric scalpel is driven can be detected more precisely in a relatively simple structure.

According to still another preferred mode of the present invention, the digital image signal is periodically updated, and the image noise detecting circuit calculates the differential every time when the digital image signal is updated and then counts number of times when the calculated differentials are at least the differential threshold value during a given period of time to determine that the image noise is superposed on the pixel to be marked when a count value thereby obtained is at least a count threshold value previously set. Thus configured, the communication forbidding signal can improve its reliability.

According to still another preferred mode of the present invention, the DSP further includes a noise cancellation circuit, the image noise detecting circuit detects whether or not the image noise is superposed on the plurality of the pixels to be marked preset in the digital image signal, and the noise cancellation circuit replaces a pixel value of the pixel to be marked determined by the image noise detecting circuit as having the image noise superposed thereon with a pixel value of the peripheral pixel around the pixel to be marked to cancel the image noise.

Thus configured, the noise cancellation circuit can cancel the image noise superposed on the digital image signal caused by the high frequency signal generated by the driven electric scalpel. As far as the image noise can be successfully removed, it is unnecessary to disrupt the communication, which improves operability.

According to still another preferred mode of the present invention, when the image noise detecting circuit once detects but thereafter no longer detects the superposed image noise, the communication control circuit discontinues to output the communication forbidding signal to restart the communication by the first communication circuit with the AFE or the communication by the second communication circuit with the processor.

Thus configured, the first communication circuit and the second communication circuit can restart their operations as soon as the electric scalpel is put to a halt. As a result, it can restart sooner to control the digital camera module (imaging device, AFE, DSP).

In the description given so far, the present invention is applied to the image processing apparatus comprising the AFE which digitalizes the image signal obtained by the imaging device, and the DSP which communicates with the AFE to image-process the digital image signal obtained by the AFE. However, the application of the present invention is not necessarily limited to such an apparatus, and is further applicable to an image input apparatus having the DSP where the AFE is not provided.

The description given so far focuses on the effectiveness exerted by the present invention to the image noise resulting from the driven electric scalpel. The present invention is similarly effective for an image noise resulting from a high frequency electric wave generated by a mobile telephone when its built-in camera is used.

### EFFECT OF THE INVENTION

According to the present invention, it is unnecessary to stop the communication even if the high frequency signal is generated nearby as far as it does not adversely impact the image signal. Therefore, an optimal control is feasible to the utmost extent. Another advantage of the present invention is no need to provide any additional circuits other than the camera module, reducing dimensions of the image processing apparatus equipped with the camera module.

### BRIEF DESCRIPTION OF THE DRAWINGS

FIG. 1 is a block diagram illustrating a schematic structure of an endoscope with an electric scalpel according to a preferred embodiment 1 of the present invention.

FIG. 2 is a block diagram illustrating a detailed structure of a DSP according to the preferred embodiment 1.

FIG. 3 is a drawing of a pixel to be marked and peripheral pixels in an image noise detecting circuit according to the preferred embodiment 1.

FIG. 4 is a drawing of a differential between a pixel value of the pixel to be marked and an average pixel value of the peripheral pixels according to the preferred embodiment 1.

FIG. 5 is a schematic illustration of a displayed monitor image when the electric scalpel is operating according to the preferred embodiment 1.

FIG. 6 is a block diagram illustrating a detailed structure of a DSP according to a preferred embodiment 2 of the present invention.

FIG. 7 is a block diagram illustrating a schematic structure of a conventional endoscope with an electric scalpel.

### PREFERRED EMBODIMENTS OF THE PRESENT INVENTION

Hereinafter, preferred embodiments of an image processing apparatus according to the present invention are described in detail referring to the drawings. The preferred embodiments described below are just exemplary modes of the present invention, and can be variously modified.

### Preferred Embodiment 1

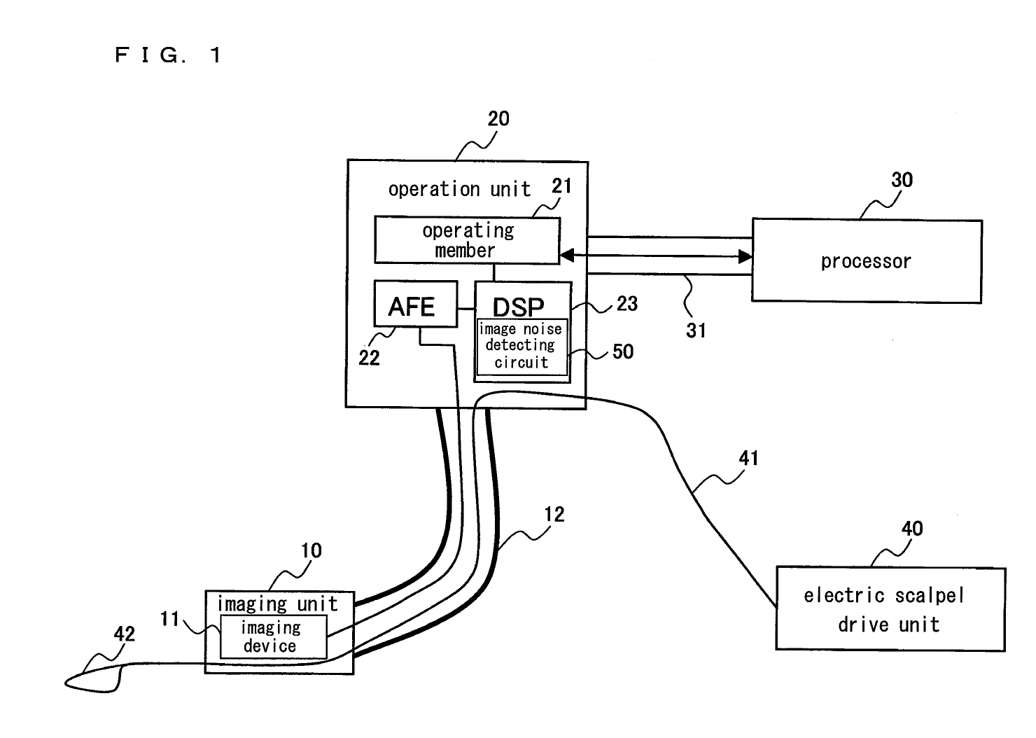

FIG. 1 is a block diagram illustrating a schematic structure of an endoscope with an electric scalpel (hereinafter, simply called endoscope) wherein a camera module according to a preferred embodiment 1 of the present invention is configured as an endoscope for medical use. The endoscope has an imaging unit 10 equipped with an imaging device 11, an operation unit 20 which operates devices provided in the endoscope, a processor 30 which variously image-processes an image signal obtained by the imaging device 11, and an electric scalpel driving unit 40.

The imaging device 11 captures an optical image of a photographic subject and converts the optical image into an electric signal representing image information. An image sensor such as CCD (Charge Coupled Device) or MOS (Metal Oxide Semiconductor) constitutes the imaging device 11. The operation unit 20 has an operating member 21 which operates the devices of the endoscope, an analog front end (hereinafter, simply called AFE) 22 which converts an analog image signal obtained by the imaging device 11 into a digital image signal, and a digital signal processor (hereinafter, simply called DSP) 23 which controls the AFE 22 and the imaging device 11. The DSP 23 is provided with an image noise detecting circuit 50. The operation unit 20 and the processor 30 are connected to each other by an extension cable 31. The DSP 23 constitutes an image input apparatus, and the AFE 22 and the DSP 23 constitute an image processing apparatus.

The processor 30 is configured to:
control the DSP 23 to output the image signal to a display monitor (not illustrated in the drawing); and
record image data on a recoding medium (not illustrated in the drawing).

The imaging unit 10 and the operation unit 20 are connected to each other by an insertion cable 12. A signal line which connects the imaging device 11 and the AFE 22 is electrically routed to the insertion cable 12. An electric scalpel cable 41 extending from the electric scalpel drive unit 40 is electrically routed to the insertion cable 12 to be connected to the imaging unit 10, and further connected to an electric scalpel 42 used to incise an affected area and having a shape protruding through an edge of the imaging unit 10. The electric scalpel cable 41 transmits a high frequency signal from the electric scalpel driving unit 40 to the electric scalpel 42. The electric scalpel drive unit 40 generates a high frequency signal having a voltage as high as a few hundred kilovolts by manipulating a switch such as a foot pedal (not illustrated in the drawing), and guides the generated signal to the electric scalpel 42 through the electric scalpel cable 41.

The DSP 23 constantly communicates with the AFE 22 to process the digital image signal outputted from the imaging device 11 via the AFE 22 and also to control the AFE 22 so that the image signal obtained by the imaging device 11 retains its optimal status. In the case where a photographic subject is dark, resulting in a low image signal level, for example, the DSP 23 controls a gain circuit provided in the AFE 22 so that the image signal level is increased. In the case where the photographic subject is bright, resulting in a high image signal level, on the contrary, the DSP 23 controls the AFE 22 and the imaging device 11 so that the imaging device 11 has a shorter charge storage time. The control signals to be supplied to the AFE 22 and the imaging device 11 may be generated by the processor 30 and then transmitted to the DSP 23 through the extension cable 31.

The operation of the electric scalpel drive unit 40 does not synchronize with the operation of the endoscope having the imaging unit 10, operation unit 20 and processor 30. Therefore, it is not possible to know the operation status of the electric scalpel 42 through the endoscope unit. In the case where the image noise is generated in a communication signal of the endoscope by the high voltage and high frequency signal passing through the electric scalpel 41, the AFE 22 and the imaging device 11 may malfunction, or what is worse, may completely stop their operations. As a result, the image data can be no longer obtained from the endoscope. To avoid the inconvenience, the image noise detecting circuit 50 is provided in the DSP 23 in the present preferred embodiment. The image noise detecting circuit 50 monitors whether or not the image noise is mingled with the image signal currently processed due to the high voltage and high frequency signal generated by the operation of the electric scalpel drive unit 40, and controls the communication circuit of the DSP 23 depending on an image noise monitoring result thereby obtained.

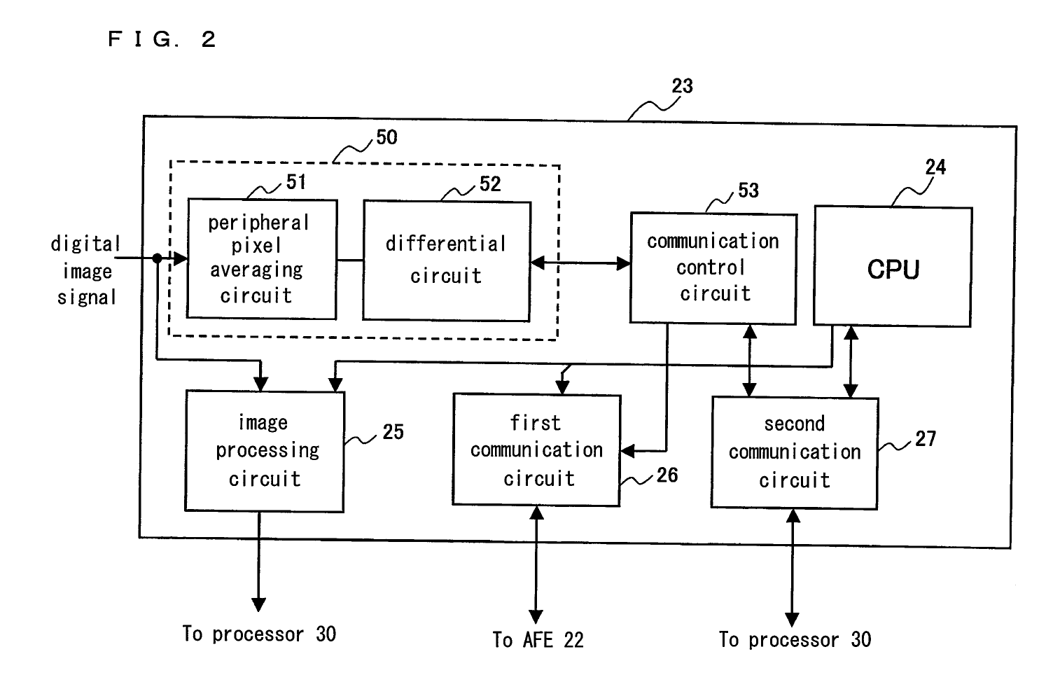

FIG. 2 is a block diagram illustrating a detailed structure of the DSP 23 according to the preferred embodiment 1. The DSP 23 has a CPU (Central Processing Unit) 24, an image processing circuit 25, a first communication circuit 26, a second communication circuit 27, a peripheral pixel averaging circuit 51, a differential circuit 52, and a communication control circuit 53.

The image processing circuit 25 generates data to be displayed and encoded data to be recorded from the digital image signal. The first communication circuit 26 communicates with the AFE 22. The second communication circuit 27 communicates with the processor 30. The peripheral pixel averaging circuit 51 and the differential circuit 52 constitute the image noise detecting circuit 50. The peripheral pixel averaging circuit 51 presets one or a plurality of pixels to be marked in one frame of the digital image signal (number of pixels to be preset is conventionally at least two), and calculates an average pixel value of a plurality of pixels around each of the preset pixels to be marked (hereinafter, called peripheral pixels). The differential circuit 52 generates a signal representing a differential between a pixel value of the pixel to be marked and the average pixel value of the peripheral pixels. The communication control circuit 53 controls the generation of a communication forbidding signal depending on the level of the differential signal. Though it is preferable that a plurality of peripheral pixels be set for one pixel to be marked to calculate an average value of their pixels values as described earlier, at least one peripheral pixel can be set for one pixel to be marked. In the case where a single peripheral pixel is set for one pixel to be marked, it is unnecessary to calculate the average pixel value.

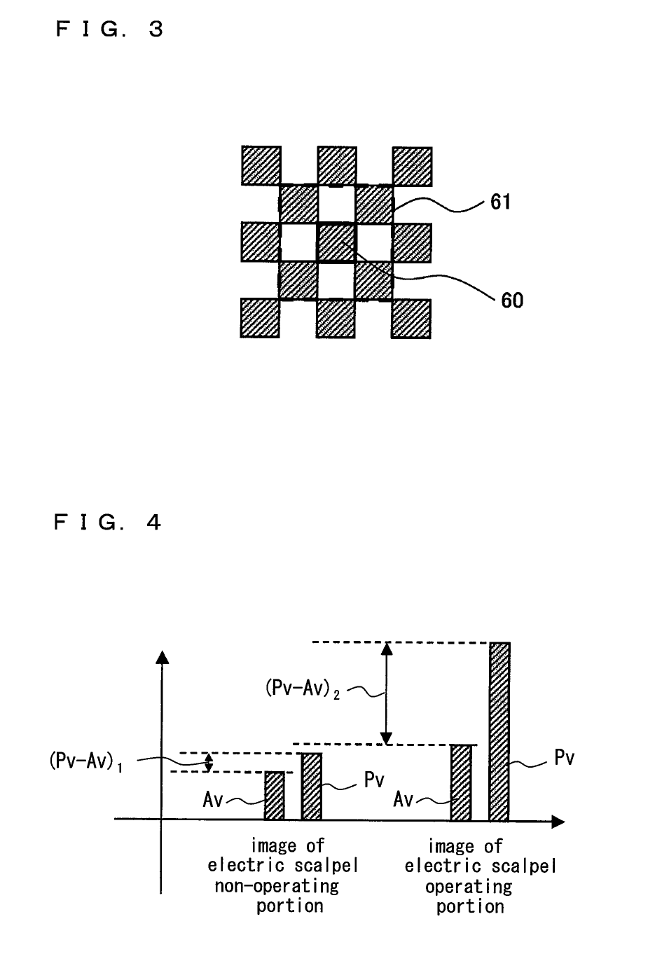

The digital image signal supplied from the AFE 22 to the DSP 23 is given to the processor 30 via the image processing circuit 25. The digital image signal is also given to the image noise detecting circuit 50. The image noise detecting circuit 50 detects the image noise generated when the electrical scalpel 42 is driven based on the digital image signal. More specifically, the digital image signal supplied to the image noise detecting circuit 50 is inputted to the peripheral pixel averaging circuit 51 positionally before the image noise detecting circuit 50. Based on the inputted digital image signal, the peripheral pixel averaging circuit 51 calculates an average pixel value of peripheral pixels 61 disposed around a pixel to be marked 60 in a checkerboard pattern and having the same color as the pixel 60 as illustrated in FIG. 3 (hereinafter, simply called average value Av) based on the inputted digital image signal.

Then, the differential circuit 52 provided behind the image noise detecting circuit 50 calculates a differential between the average value Av of the peripheral pixels 61 and a pixel value Pv of the pixel to be marked 60 (Pv-Av). As illustrated in FIG. 4, the differential circuit 52 determines that there is no image noise generated by the driven electric scalpel when the calculated differential (Pv-Av) is smaller than a differential threshold value Th1 previously set ((Pv-Av)<Th1). The differential circuit 52 determines that the image noise was generated by the driven electric scalpel when the calculated differential (Pv-Av) is at least the differential threshold value Th1 ((Pv-Av)≧Th1). The differential circuit 52 notifies the communication control circuit 53 of the determination result whether or not the image noise was generated.

The communication control circuit 53 does not generate a communication forbidding signal Pro when notified by the differential circuit 52 that no image noise was generated by the driven electric scalpel. The communication control circuit 53 generates the communication forbidding signal Pro when notified by the differential circuit 52 that the image noise was generated by the driven electric scalpel.

The communication control circuit 53 supplies the communication forbidding signal Pro to the first communication circuit 26 and the second communication circuit 27. The first communication circuit 26 which received the communication forbidding signal Pro discontinues the communication with the AFE 22. The second communication circuit 27 which received the communication forbidding signal Pro discontinues the communication with the processor 30.

The respective structural elements are thus controlled, and the communications by the first and second communication circuits 26 and 27 are selectively discontinued whenever it is determined that the electric scalpel drive unit 40 is in action and the image noise is thereby is generated. Accordingly, the AFE 22 can be precisely controlled to a just right extent. The second communication circuit 27 notifies the processor 30 of the occurrence of the image noise due to the operation of the electric scalpel drive unit 40 before stopping the communication with the processor 30 based on the communication forbidding signal Pro.

The CPU 24 generates a control signal C1 which controls the AFE 22 and the imaging device 11 based on the communication signal supplied from the processor 30 via the second communication circuit 27. The CPU 24 supplies the generated control signal C1 to the AFE 22 via the first communication circuit 26 to control the AFE 22, and further control the imaging device 11 via the AFE 22. The CPU 24, while thus controlling the respective devices, detects the operation statuses of the imaging device 11, AFE 22 and DSP 23, and transmits the detected operation statuses to the processor 30 via the second communication circuit 27.

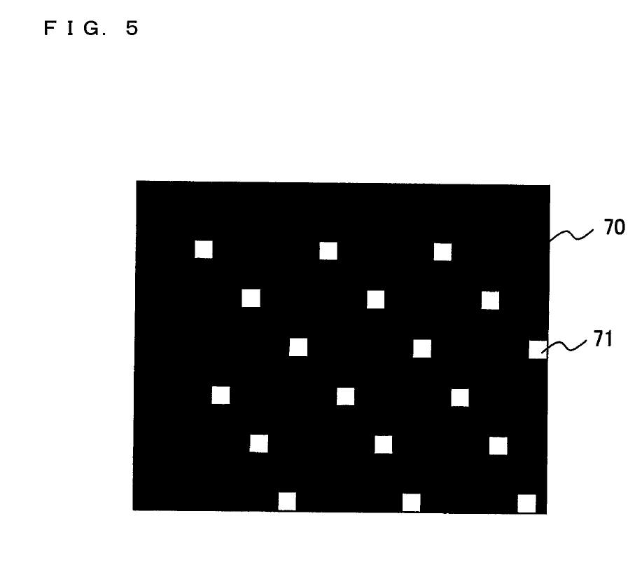

FIG. 5 is a schematic illustration of an outputted image signal when the electric scalpel drive unit 40 is currently operating. In the drawing, a black subject is photographed to simplify the illustration. Assuming that the electric scalpel drive unit 40 is activated by the high voltage and high frequency signal and the image noise is thereby generated, the image noise due to the driven electric scalpel is superposed on the image signal. In the drawings, white noises 71 are superposed on a black monitor image 70. The image noise detecting circuit 50 detects the image noises 71 due to the driven electric scalpel, and controls the AFE 22 with a high accuracy based on the detection result.

The digital image signal is periodically updated based on, for example, frame cycles of the image signal. The image noise detecting circuit 50 may calculate the differential (Pv-Av) every time when the digital image signal is updated, and counts number of times when the calculated differentials (Pv-Av) are at least the differential threshold value Th1 during a given period of time (for example, one second) to determine that the image noise is superposed on the pixel to be marked when a count value thus obtained is at least a count threshold value Th2 previously set (Cou≧Th2). The count threshold value Th2 may be an arbitrary value equal to “1” or larger. The communication control circuit 53 generates the communication forbidding signal Pro based on the image noise thus detected. The image noise is basically detected by the differential circuit 52, however, may be detected by the communication control circuit 53.

In the description given earlier, the number of times when each of the differentials (Pv-Av) is at least the differential threshold value Th1 is counted during the given period of time (for example, one second). Alternatively, number of the pixels to be marked in which the differential (Pv-Av) is at least the differential threshold value Th1 may be counted in one frame of the digital image signal to determine that the image noise is superposed on the one frame when a count value thus obtained is at least a count threshold value Th3 previously set (Cou≧Th3).

In the case where the differential (Pv-Av) is smaller than the differential threshold value Th1 ((Pv-Av)<Th1) or the count value Cou is smaller than the count threshold value Th2 (Cou<Th2), the communication control circuit 53 discontinues to output the communication forbidding signal Pro. Accordingly, the first communication circuit 26 and the second communication circuit 27 restart their communications as soon as the operation of the electric scalpel 42 stops, and the camera module (imaging device, AFE, DSP) is then controlled again. The DSP 23 may notify the processor 30 of the discontinuation of the communication forbidding signal Pro via the second communication circuit 27.

### Preferred Embodiment 2

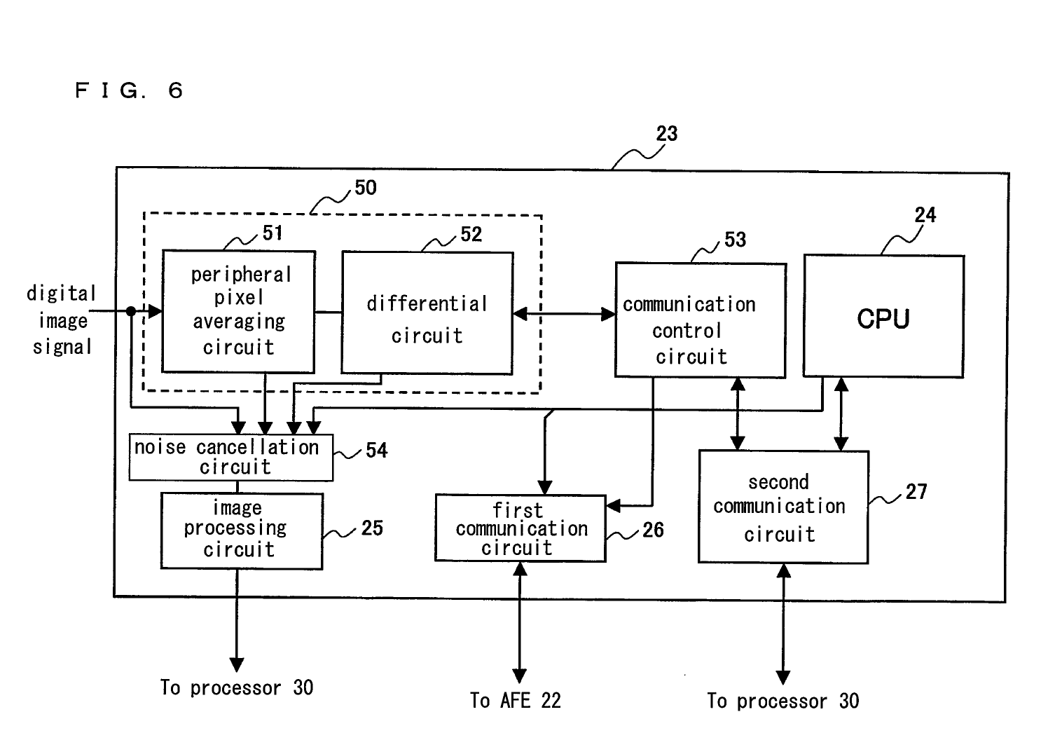

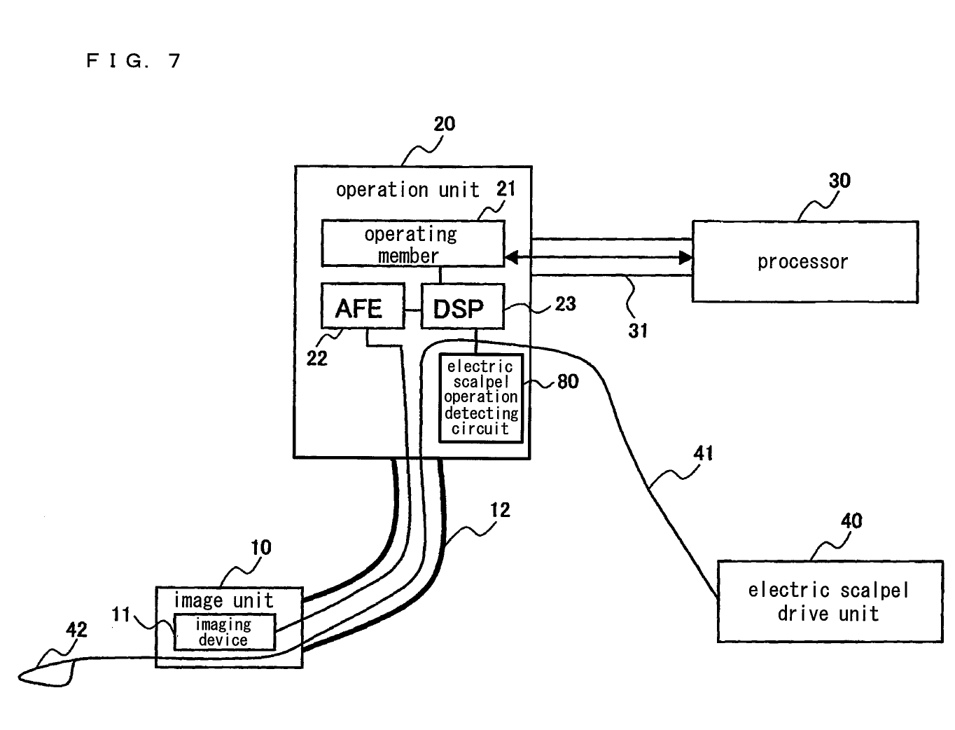

FIG. 6 is a block diagram illustrating a detailed structure of a DSP 23 according to a preferred embodiment 2 of the present invention. In FIG. 6, the same reference symbols as those illustrated in FIG. 2 according to the preferred embodiment 1 denote the same structural elements. The DSP 23 according to the present preferred embodiment is technically characterized in that a noise cancellation circuit 54 is provided therein. The noise cancellation circuit 54 replaces a pixel value of a pixel to be marked determined by the image noise detecting circuit 50 as “having the image noise superposed thereon” with an average value Av of peripheral pixels around the pixel to be marked (calculated by the peripheral pixel averaging circuit 51) so that the image noise is cancelled. The rest of the structure is similar to that of the preferred embodiment 1, and will not be described again.

In the present preferred embodiment, the image noise generated when the electric scalpel 42 is in action and superposed on the digital image signal can be removed by the noise cancellation circuit 54. As far as the image noise is successfully removed, it is unnecessary to stop the communication, which improves operability.

In the preferred embodiments 1 and 2 described so far, the present invention is applied to the endoscope with the electric scalpel. The present invention is further applicable to a built-in camera of a mobile telephone, in which case the present invention can succeed in avoiding malfunction of a camera module caused by a high frequency wireless communication with outside of the device.

### INDUSTRIAL APPLICABILITY

The present invention can avoid a control failure caused by an image noise due to an external factor in a communication between an AFE and a DSP in a camera module or a communication between the camera module and a processor which controls other devices. The present invention can exert a particularly advantageous effect when applied to an endoscope with an electric scalpel. The present invention is also applicable to a built-in camera of a mobile telephone, in which case malfunction of a camera module caused by a high frequency wireless communication with outside of the device can be effectively avoided.

### DESCRIPTION OF REFERENCE SYMBOLS

10 imaging unit
11 imaging device
12 insertion cable
20 operation unit
21 operating member
22 AFE (analog front end)
23 DSP (digital signal processor)
24 CPU
25 image processing circuit
26 first communication circuit
27 second communication circuit
30 processor
31 extension cable
40 electric scalpel drive unit
41 electric scalpel cable
42 electric scalpel
50 image noise detecting circuit
51 peripheral pixel averaging circuit
52 differential circuit
53 communication control circuit
54 noise cancellation circuit
60 pixel to be marked
61 peripheral pixel
70 monitor image
71 image noise resulting from driven electric scalpel

What is claimed is:

1. An image processing apparatus comprising:
an AFE for generating a digital image signal from an image signal; and
a DSP for image-processing the digital image signal, wherein
the DSP includes:
a first communication circuit for communicating with the AFE;
an image noise detecting circuit for detecting whether or not an image noise is superposed on the digital image signal; and
a communication control circuit for outputting a communication forbidding signal when the image noise detecting circuit detects that the image noise is superposed on the digital image signal, and
the first communication circuit arrests the communication when the communication forbidding signal is detected.

2. The image processing apparatus as claimed in claim 1, wherein
the image noise detecting circuit presets one or a plurality of pixels to be marked and a peripheral pixel around the pixel to be marked in the digital image signal, and determines that the image noise is superposed on the pixel to be marked when a differential between a pixel value of the pixel to be marked and a pixel value of the peripheral pixel is at least a differential threshold value previously set.

3. The image processing apparatus as claimed in claim 2, wherein
the image noise detecting circuit presets a plurality of the peripheral pixels for the one pixel to be marked, and uses an average pixel value of the plurality of the peripheral pixels as a pixel value of the peripheral pixels.

4. The image processing apparatus as claimed in claim 2, wherein
the digital image signal is periodically updated, and the image noise detecting circuit calculates the differential every time when the digital image signal is updated and then counts number of times when the calculated differentials are at least the differential threshold value during a given period of time to determine that the image noise is superposed on the pixel to be marked when a count value thereby obtained is at least a count threshold value previously set.

5. The image processing apparatus as claimed in claim 2, wherein
the digital image signal is periodically updated, and the image noise detecting circuit calculates the differential every time when the digital image signal is updated and then counts number of the calculated differentials at least the differential threshold value in one frame to determine that the image noise is superposed on the pixel to be marked when a count value thereby obtained is at least a count threshold value previously set.

6. The image processing apparatus as claimed in claim 1, wherein
the DSP further includes a second communication circuit for communicating with a processor which controls the DSP, and the second communication circuit arrests the communication when the communication forbidding signal is detected.

7. The image processing apparatus as claimed in claim 6, wherein
the communication control circuit outputs the communication forbidding signal to the processor using the second communication circuit.

8. The image processing apparatus as claimed in claim 3, wherein
the image noise detecting circuit further includes:
a peripheral pixel averaging circuit for calculating the average pixel value of the peripheral pixels; and
a differential circuit for calculating a differential between the pixel value of the pixel to be marked and the average pixel value, wherein
the image noise detecting circuit determines that the image noise is superposed on the pixel to be marked when the differential between the pixel value of the pixel to be marked and the average pixel value is at least the differential threshold value.

9. The image processing apparatus as claimed in claim 1, wherein
the DSP further includes a noise cancellation circuit, the image noise detecting circuit detects whether or not the image noise is superposed on the plurality of the pixels to be marked preset in the digital image signal, and the noise cancellation circuit replaces a pixel value of the pixel to be marked determined by the image noise detecting circuit as having the image noise superposed thereon with a pixel value of the peripheral pixel around the pixel to be marked to cancel the image noise.

10. The image processing apparatus as claimed in claim 9, wherein
the noise cancellation circuit presets a plurality of the peripheral pixels for the one pixel to be marked and then uses an average pixel value of the plurality of the peripheral pixels as a pixel value of the peripheral pixels.

11. The image processing apparatus as claimed in claim 1, wherein
when the image noise detecting circuit once detects but thereafter no longer detects the superposed image noise, the communication control circuit discontinues to output the communication forbidding signal to restart the communication by the first communication circuit with the AFE.

12. The image processing apparatus as claimed in claim 6, wherein
when the image noise detecting circuit once detects but thereafter no longer detects the superposed image noise, the communication control circuit discontinues to output the communication forbidding signal to restart the communication by the second communication circuit with the processor.

13. An image input apparatus wherein an AFE comprises a DSP for image-processing a digital image signal generated from an image signal, and
the DSP includes:
a first communication circuit for communicating with the AFE;
an image noise detecting circuit for detecting whether or not an image noise is superposed on the digital image signal; and
a communication control circuit for outputting a communication forbidding signal when the image noise detecting circuit detects that the image noise is superposed on the digital image signal, and
the first communication circuit arrests the communication when the communication forbidding signal is detected.

14. The image input apparatus as claimed in claim 13, wherein
the image noise detecting circuit presets one or a plurality of pixels to be marked and a peripheral pixel around the pixel to be marked in the digital image signal, and determines that the image noise is superposed on the pixel to be marked when a differential between a pixel value of the pixel to be marked and a pixel value of the peripheral pixel is at least a differential threshold value previously set.

15. The image input apparatus as claimed in claim 14, wherein
the image noise detecting circuit presets a plurality of the peripheral pixels for the one pixel to be marked, and uses an average pixel value of the plurality of the peripheral pixels as a pixel value of the peripheral pixels.

16. The image input apparatus as claimed in claim 14, wherein
the digital image signal is periodically updated, and the image noise detecting circuit calculates the differential every time when the digital image signal is updated and then counts number of times when the calculated differentials are at least the differential threshold value during a given period of time to determine that the image noise is superposed on the pixel to be marked when a count value thereby obtained is at least a count threshold value previously set.

17. The image input apparatus as claimed in claim 14, wherein
the digital image signal is periodically updated, and the image noise detecting circuit calculates the differential every time when the digital image signal is updated and then counts number of the calculated differentials at least the differential threshold value in one frame to determine that the image noise is superposed on the pixel to be marked when a count value thereby obtained is at least a count threshold value previously set.

18. The image input apparatus as claimed in claim 13, wherein
the DSP further includes a second communication circuit for communicating with a processor which controls the DSP, and the second communication circuit arrests the communication when the communication forbidding signal is detected.

19. The image input apparatus as claimed in claim 18, wherein
the communication control circuit outputs the communication forbidding signal to the processor using the second communication circuit.

20. The image input apparatus as claimed in claim 15, wherein
the image noise detecting circuit further includes:
a peripheral pixel averaging circuit for calculating the average pixel value of the peripheral pixels; and
a differential circuit for calculating a differential between the pixel value of the pixel to be marked and the average pixel value, wherein
the image noise detecting circuit determines that the image noise is superposed on the pixel to be marked when the differential between the pixel value of the pixel to be marked and the average pixel value is at least the differential threshold value.

21. The image input apparatus as claimed in claim 13, wherein
the DSP further includes a noise cancellation circuit, the image noise detecting circuit detects whether or not the image noise is superposed on the plurality of the pixels to be marked preset in the digital image signal, and the noise cancellation circuit replaces a pixel value of the pixel to be marked determined by the image noise detecting circuit as having the image noise superposed thereon with a pixel value of the peripheral pixel around the pixel to be marked to cancel the image noise.

22. The image input apparatus as claimed in claim 21, wherein
the noise cancellation circuit presets a plurality of the peripheral pixels for the one pixel to be marked and then uses an average pixel value of the plurality of the peripheral pixels as a pixel value of the peripheral pixels.

23. The image input apparatus as claimed in claim 13, wherein
when the image noise detecting circuit once detects but thereafter no longer detects the superposed image noise, the communication control circuit discontinues to output the communication forbidding signal to restart the communication by the first communication circuit with the AFE.

24. The image input apparatus as claimed in claim 18, wherein
when the image noise detecting circuit once detects but thereafter no longer detects the superposed image noise, the communication control circuit discontinues to output the communication forbidding signal to restart the communication by the second communication circuit with the processor.
